(19) United States
(12) Patent Application Publication
(10) Pub. No.: US 2002/0178356 A1
(43) Pub. Date: Nov. 28, 2002

(54) Method for setting up secure connections

(75) Inventor: Samuli Mattila, Kuopio (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: SSH Communications Security Corp.

(21) Appl. No.: 10/078,245

(22) Filed: Feb. 15, 2002

(30) Foreign Application Priority Data
Feb. 15, 2001 (FI) 20010293

(51) Int. Cl. H04L 9/00

(52) U.S. Cl. 713/156

(57) ABSTRACT

According to the invention, the problem of checking the identity of others is alleviated by creating a mechanism, which allows users to trust and utilize the checking work performed by certain other users, so that every user need not check and confirm the identity of every other user. This can be accomplished by allowing a user who has checked that the identity of a number of other users truly correspond to their certificates, produce a list of these checked certificates, so that other users can import the list of checked certificates into their systems.

### BACKGROUND OF THE INVENTION

1. Field of the Invention

The present invention is related to connections in IP (Internet Protocol) based networks, especially connections according to the IPSec protocol. Specifically, the invention is directed to a method according to the first independent method claim.

2. Description of Related Art

The basic protocols used in the Internet, namely the IP protocol [IP] and TCP protocol [TCP] were created in an environment, where security was not a concern. Consequently, the security of a basic TCP/IP network is very poor if not practically nonexistent, if no further measures are taken. Many different approaches to improve the security of TCP/IP networks have been taken. One of the most popular techniques is the IPSec protocol [IPSec], which at the time of writing this application has established itself as an industry standard. The IPSec protocol provides a framework for establishing, using, and terminating secure connections over untrusted networks. The IPSec protocol does not strictly define which encryption methods are used. The encryption method is negotiated by the communicating parties during setup of a connection, which allows the change and improvement of encryption methods without breaking the IPSec protocol itself. IPSec is by construction a unidirectional protocol. For two-way communication, two communication channels must be set up, one for each direction. The IPSec protocol is described in further detail in the reference [IPSec] and in the documents referred to therein.

Some of the acronyms used in this application are the following:

| | |
|---|---|
| AH | authenticated header |
| CA | certificate authority |
| ESP | encapsulated security payload |
| IKE | Intcrnct Key Exchange |
| IP | Intcrnct Protocol |
| IPSec | Internet Protocol Security |
| ISAKMP | Internet Security Association and Key Management Protocol |
| PKI | public key infrastructure |
| RA | regional authority |
| SA | security association |
| TCP | Transmission Control Protocol |

The IKE protocol [IKE] is a mechanism allowing automatic key management, i.e. a mechanism for negotiating and obtaining authenticated keying material for security associations in a protected manner for use with ISAKMP, and for other SAs such as AH and ESP security associations for the IPSec protocol.

A security association (SA) is a security protocol specific set of parameters that defines the services and mechanisms necessary to protect traffic at that particular security protocol location. These parameters can include algorithm identifiers, modes, cryptographic keys, and other parameters necessary for the specific protocol.

The Internet Security Association and Key Management Protocol (ISAKMP) [ISAKMP] defines the procedures for authenticating a communicating node, creation and management of security associations, and key generation techniques.

These protocols allow the building of secured network systems, and provide solutions for many practical problems associated with management of keys and other critical information. Key management, and the management of certificates which are typically used for authentication purposes, becomes a major problem when the number of communicating nodes within a secured network rises above a handful of nodes. A widely accepted structure for solving this problem is the PKI (public key infrastructure) system, which relies on a hierarchy of certificate authorities (CA) for providing a chain of certificates traceable to a common authority trusted by both communicating parties. CAs issue certificates for parties needing a proof of identity, and during the issue process check the true identity of the party requesting a certificate. This principle makes the management of extremely large numbers of certificates feasible. However, a CA based structure is complicated and too heavy a solution for many purposes, especially when the number of communicating parties is not very high, or for example when the group of communicating parties do not have any central organization or resources of a commercial organization. The complicated nature of a CA based structure is evident from the observation, that at the time of writing this application the associated standards have been in usable state for several years, many large corporations are manufacturing and selling the necessary technology, and many government organizations in many countries have programs for establishing a PKI structure for use by the citizens; despite all this the number of full-blown, working PKI structures is very low, and they are far from mainstream technology in common use. For many purposes, a lighter system for providing authentication for users of IPSec based secure communications systems is needed. For example, many voluntary organizations such as various user and hobby groups, student organizations, and other interest groups often have a need for secure communications, without sufficient resources for a full PKI system.

### SUMMARY OF THE INVENTION

According to the invention, the problem of checking the identity of others is alleviated by creating a mechanism, which allows users to trust and utilize the checking work performed by certain other users, so that every user need not check and confirm the identity of every other user. This can be accomplished by allowing a user who has checked that the identity of a number of other users truly correspond to their certificates, produce a list of these checked certificates, so that other users can import the list of checked certificates into their systems. The acts of producing such a collection of certificates and placing it available to at least one other user is called sharing in this application.

When importing such a shared list or collection of certificates, a user can accept all of the certificates in the list in one operation, without explicit checking of each and every certificate separately. When enough users have imported and accepted checked certificate collections of other users, a network of bidirectional trust is born. An important benefit of the invention is, that no central authority is needed for creating the individual certificates. Each person can create his/hers own certificate (such as a so called self-signed certificate), and since one trusted person has checked that the certificate corresponds to the individual which the certificate purports to represent, others can trust the certificate.

In an advantageous embodiment of the invention, the inventive functionality is implemented in an IPSec client program in the local computer of a user. When setting up a connection to a remote computer of another user, the IPSec client program fetches automatically the certificate of the remote computer and allows the user to decide, whether to trust the certificate or not. Naturally, if the remote end was already known and its certificate previously obtained and accepted, there is no need to ask the user again. The IPSec client program then sets up an IPSec connection from the local computer to the remote computer for achieving secrecy of communications from the local computer to the remote computer. The remote computer may perform in the way set as default in that computer; if secured connections are desired, the remote computer can perform the same steps as the local computer, obtaining the certificate and setting up a secured connection. An advantage here is, that the process of setting up of a secured connection from the local to the remote computer can be performed automatically without disturbing the remote user at all. The remote user does not even need to know the identity of the local user, nor does he need to know that the communication from the local computer to the remote computer proceeds via IPSec. This method of establishing unidirectional secured connections is therefore very easy and convenient. After a time, when the user has set up connections to computers of several users, the user has accumulated a collection of accepted certificates. By sharing these certificates with other users, the other users can take these certificates into use for obtaining the benefit of automatic setting up of secured communications to those users, whose certificates were shared.

For example, let us consider four users, named A, B, C, and D. Let us assume that A knows personally persons B, C, and D. Consequently, A is able to check that the identity represented by certificates sent to A by the others really correspond to the real identity of persons B, C, and D. Person A can perform the checking for example by calling the others by telephone thereby personally recognizing the others and asking them to recite an identification string of each person's certificate, and by comparing the recited identification string to the string obtainable from the received certificates. Next, person A prepares a list of the checked certificates and either sends the list to the others or places it in a place accessible by the others. Persons B, C, and D can then import the list into their systems. Preferably, persons B, C, and D should check that the list is indeed prepared by A and not by a malicious outsider. The checking can be performed in various ways. For example, A can add a digital signature to the list, whereby the others can check his signature using a previously obtained copy of the certificate of person A. In such a scheme, persons B, C, and D should check that the certificate of person A corresponds to the real person A. This checking can for example be performed during the same phone call, when person A checks the other person. After importing the list prepared by A, persons B, C, and D can initiate mutual communications without need to check the identity of the others, due to the trust placed on the checking performed by A. In this example, persons B, C, and D only need to check the identity of A to be able to use the certificates of three others. This example of only four persons is very small example, whereby the saving of trouble is not very high in practice, but as the size of the group grows, the benefits of the inventive arrangement become larger.

Further, if all persons involved do not know each other, the checking of the identity of the unfamiliar persons is a problem in itself. Let us assume B does not know persons C and D, but only knows person A. Checking of the identity of persons C and D would present a very large problem for B, especially if persons C and D are too far away for a personal meeting and checking of passports or other personal identification. However, as A knows personally both C and D and B knows A, B can trust A's judgment and accept the identities of C and D. This is a considerable advantage.

Naturally, the security of such an arrangement requires that those users importing a list of checked certificates really trust the user who has performed without error and without any wrongful intention the checking of the certificates in said list. However, one of the cornerstones of the invention is the realizations that this kind of security is useful and sufficient in many circumstances, where the cost and trouble of creation, maintaining and use of a full IKE system would be out of proportion regarding the available resources and needed security level.

The invention allows the setup of a network of IPSec connections easily and simply, without any need for a centralized certificate management system such as an IKE based system. Users can accept certificate collections of other users, thereby creating a network of bidirectional trust from collections representing unidirectional trust. This network of trust can be created without requiring each and every user taking part in the network to check the identities of all other users. Such an inventive scheme is very advantageous for groups which do not have strong centralized structure, such as user groups, various interest groups, and many other types of groups of people. The inventive scheme is very advantageous also for smaller organizations, for which a full IKE and certificate authority based centrally controlled certificated management structure would be a too heavy solution. For example, in a small company of for example around 30 persons, at least one or two persons are likely to know all others. These persons can then receive the certificates of all others, and easily check that each certificate corresponds to the person the certificate purports to represent. All others can then import the checked certificate list of these persons performing the checking, whereafter every employee of this exemplary company can communicate with everyone else in the company and always be sure, that the other employee really is the person which his/hers certificate says him/her to be.

In an advantageous embodiment of the invention, a computer node can import a plurality of such certificate lists and manage them separately, whereby the computer node can enable, disable and/or remove any of these imported certificate lists at will. Further, the enabling, disabling and/or removal of certificate lists can be made dependent on certain conditions. For example, a certificate list obtained from a member of a community can be enabled only for the time, when the computer node has an IPsec connection to a server of the community. For example, the community can be his place of work, in which case a certificate list imported from a server at the company is used only during access to the company's intranet, and disabled otherwise. Such functionality can be used for example for screening unwanted communication attempts.

At the time of writing this application the IPSec protocol is the most widespread protocol of its kind, which is why this application frequently refers to IPSec as an example. However, the invention is not limited for use only with IPSec, since the inventive idea can also be used with any other secure communication protocol which establishes unidirectional connections.

### BRIEF DESCRIPTION OF THE DRAWINGS

Various embodiments of the invention will be described in detail below, by way of example only, with reference to the accompanying drawings, of which

FIG. 1 illustrates a method according to an aspect of the invention,

FIG. 2 illustrates a further method according to an advantageous embodiment of the invention,

FIG. 3 illustrates a system according to an aspect of the invention, and

FIG. 4 illustrates a further method according to an advantageous embodiment of the invention.

### DETAILED DESCRIPTION OF A PREFERRED EMBODIMENT

The exemplary embodiment of the invention presented in this description are not to be interpreted to pose limitations to the applicability of the appended claims. The verb “to comprise” is used as an open limitation that does not exclude the existence of also unrecited features. The features recited in depending claims are mutually freely combinable unless otherwise explicitly stated.

In an advantageous embodiment of the invention, the obtaining of the certificate of the other communicating party is performed automatically by using a partial IKE [IKE] negotiation. This is a very advantageous way, since IKE support is practically necessary for any full-blown IPSec client, whereby in most cases no new functionality is needed at the remote end for the automated obtaining of the certificate to work.

Generally, some of the aims of a normal IKE negotiation is to discover the certificates of both parties intending to communicate and communication parameters such as IKE SA (security association) and IPSec SA parameters.

In the present embodiment, when a new connection is to be set up, the certificate of the other party is obtained by executing a part of an IKE negotiation. The inventive system triggers an IKE negotiation with the other party and continues the negotiation, until the certificate of the other party is received. The system can then show an identification string of the certificate to the user and ask the user, whether the certificate should be trusted. If the user responds by accepting the certificate, at least the certificate is stored in a memory means.

The certificate of the other party can be obtained during the IKE negotiation using ISAKMP [ISAKMP] phase-1 (main mode) messages. This messaging can be used for only obtaining the certificate of the other party by sending a CR (Certificate Request) payload in an ISAKMP message. The CR payload can advantageously be empty. In the response message which the remote party is required to send as a response to receiving a CR payload, the remote party (responder in ISAKMP terminology) sends its certificate (or certificate chain) back in a CERT payload.

The method of indicating which of the stored certificates are trusted and which are not can be implemented in many ways. For example, if only trusted certificates are stored, then the fact that a given certificate was stored at some point in time is an indication, that the user has checked or at least trusts the certificate. As another example, the inventive software can store an indication along with a particular certificate indicating that the certificate is trusted. In such a case, the collection of stored certificates can comprise both trusted and untrusted certificates. As a third example, the inventive software can digitally sign a trusted certificate using a signing key of the user, and store the digitally signed certificate. Later, the signature indicates that the user whose signing key was used for the signature trusts the particular certificate.

The format of a shared collection of trusted certificates can also be different in different embodiments of the invention. Advantageously, the collection is protected against tampering by outsiders. For example, the collection can advantageously be digitally signed by the user who has shared the collection to other users. Further, each of the certificates can advantageously each be digitally signed by the user sharing the collection, which would allow the extraction of single certificates from the collection while maintaining the integrity of the signature of the particular certificate. The shared collection can also be encrypted so that only certain desired users can import the shared collection and others do not gain the information of whom the user sharing the collection communicates with. The encryption can be performed for example using public key cryptography, in which case the collection can be encrypted using the public keys of each user, who is allowed to import the collection. As a man skilled in the art realizes, the collection can be shared in many different technical formats, such as a single ASCII file, in some database format, or in many other different formats.

The collection of certificates shared for use by other users can also comprise other information in addition to the certificates. For example, the collection can comprise terms and rules regarding the use, for which the certificates were accepted. For example, a certificate can be accepted for certain type or types of activity or communication only, and for example for a certain time period only. As a man skilled in the art knows, such rules can be devised based on many different parameters, whereby the invention is not limited only to these examples described here.

According to a further advantageous embodiment of the invention, the procedure used for obtaining a certificate of the other party is also used for obtaining in addition to the certificate or certificates also further information about the other party and/or about the connection between the communicating hosts. This further information can then be used later for adjusting various parameters and connection methods in a later connection attempt to the other party. Such an embodiment can be used for example to provide automatic configuration functionality for an IPsec client program. Such further information can comprise for example

vendor identification information about the system used at the other party,

identity of the other party,

other information listed in a certificate provided by the other party, and

any address transformations or other changes in the packets during transit between the two hosts.

This list is not intended to be an exhaustive list; it merely lists certain examples of information observable during a partial IKE negotiation.

For example, the exchange of packets in said procedure can be used for detecting the presence of a network address translation (NAT) device between the two communicating hosts for determining, whether NAT traversal functionality is needed for this connection. This can be observed for example by monitoring the source port of received packets. The IKE protocol uses UDP port 500; if the source port is different from 500, NAT traversal functionality is probably needed—at least it is then reasonable to include NAT discovery payloads in later connection initialization negotiations with the same remote party. The existence of NAT function on the data path can also be detected as the [NAT] documents describe, by including NAT discovery payloads in the IKE exchange. NAT traversal technique is described in further detail in the [NAT] documents, which are incorporated herein by reference.

In an advantageous embodiment of the invention, the procedure can be used to determine if further connection established mechanisms need to be invoked. For example, it is known in the prior art that a host connecting to an internal LAN via an IPsec connection can be assigned an internal IP address from the internal LAN. This can be effected by using the so called DHCP over IPsec mechanism [DHCP], in which the remote host first establishes an IPsec connection to a security gateway (SGW) separating the internal LAN from the public Internet, then sends a request to A DHCP (dynamic host configuration protocol) server within the internal LAN, which assigns an internal IP address to the remote host. Thereafter the SGW forwards all traffic destined to that IP address to the remote host via the previously established IPsec connection. In this scenario, the remote host appears to be present at the internal LAN just like any other internal host. In the context of the present invention, the procedure for obtaining a certificate of the other party can be used to obtain information about whether a DHCP over IPsec procedure should be initiated after establishment of an IPsec connection to the other end.

Advantageously, also information about possible IKE SA and IPSec SA parameters obtained from the partial IKE negotiation can be used in the setting up of the IPSec connection. This has the advantage, that when SA parameters suitable for the other party have been obtained during the partial IKE negotiation, it is possible to avoid unnecessary proposal conflicts during IPSec negotiation, therefore avoiding unnecessary signalling which might occur without such information obtained before commencement of IPSec negotiation.

The IKE protocol allows the initiator to list a plurality of proposals for SA parameters such as encryption methods in the initial exchange, in order to provide some leeway for the responder to select the most suitable of the proposals. To give the responder the widest possible choice, an initiator can list all ciphers and other parameters it supports. However, such a list can become large and produce practical problems due to the size of the packet and also due to the possibility of fragmenting of the packet during transit to the respondent. It is not uncommon for IPsec implementations to have problems in interpreting large and possibly fragmented IKE payloads listing proposals which they do not support. Also, it is not uncommon for firewalls to drop all fragmented traffic. Therefore, in an advantageous embodiment of the invention, the initiating node observes if the partial IKE negotiation proceeds successfully. If it does not proceed successfully, the initiating node start a second negotiation with a restricted list of parameter proposals.

### DESCRIPTION OF CERTAIN FURTHER ASPECTS OF THE INVENTION

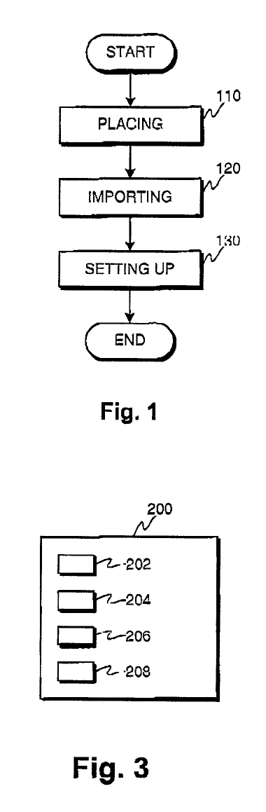

According to a first further aspect of the invention, a method for providing authentication for setting up secure connections between a plurality of network nodes is provided. A flow chart according to this aspect of the invention is shown in FIG. 1. According to this first aspect of the invention, the method comprises at least the steps of

placing 110 a collection of accepted certificates comprising at least one accepted certificate available for other nodes by said first node,

importing 120 said collection by at least one other node than said first node,

setting up 130 of at least one secure connection by at least one of said at least one other node to a destination node whose certificate was imported as a part of said collection, and automatically accepting the authenticity of said destination node.

According to an advantageous embodiment of said first aspect of the invention, the method further comprises at least the steps of

automatically obtaining 140 a certificate of a second node by a first node,

displaying 150 at least an identification string of said certificate to the user of said first node,

receiving 160 an indication of acceptance or rejection of trust regarding said certificate from said user, and in the case of receiving an indication of acceptance, storing 170 at least an indication of the acceptance and said certificate, and

setting 180 up a secure connection from said first node to said second node.

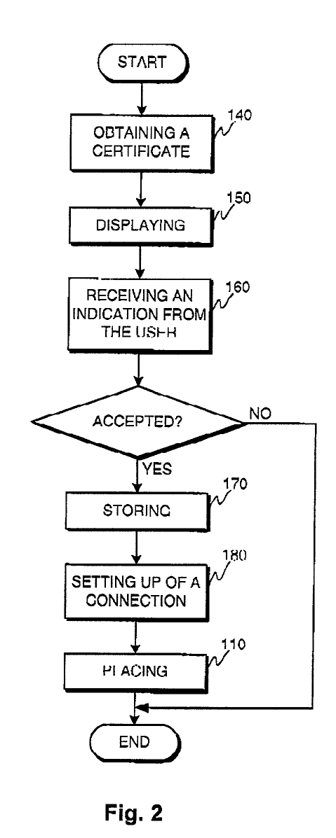

FIG. 2 further shows a step of placing 110 a collection of accepted certificates comprising at least one accepted certificate available for other nodes.

According to a further advantageous embodiment of said first aspect of the invention, the method further comprises at least the step of digitally signing said collection by said first node.

According to a further advantageous embodiment of said first aspect of the invention, the method further comprises at least the steps of encryption of said collection by said first node.

The invention is not limited to any particular encryption method and algorithm. A man skilled in the art realizes that many different encryption methods could be used.

According to a further advantageous embodiment of said first aspect of the invention, the method further comprises at least the step of saving certificate use policy information in said collection by said first node.

As discussed previously, this policy information can comprise various rules and conditions describing the uses for which the certificate has been accepted for by the accepting user, such as validity for certain operations only, validity periods, and other conditions.

According to a further advantageous embodiment of said first further aspect of the invention, the method further comprises at least the step of digitally signing each certificate in said collection by said first node.

The signing of single certificates can for example be performed when the particular certificate is obtained from the corresponding node and accepted by the user, so that the certificate is originally stored as undersigned. In such an embodiment of the invention, the existence of a signed certificate indicates that the certificate was accepted by the user.

According to a second further aspect of the invention, the inventive idea is realized as a method in a single network node. This second further aspect of the invention provides a method in a network node for setting up secure connections between the node and other network nodes. The method according to this aspect comprises at least the steps of

automatically obtaining a certificate of a second node by the network node,

displaying an identification string of said certificate to the user of the network node,

receiving an indication of acceptance or rejection of trust regarding said certificate from said user, and in the case of receiving an indication of acceptance, storing at least an indication of the acceptance and said certificate,

setting up a secure connection from the network node to said second node, and

placing a collection of accepted certificates comprising at least one accepted certificate available for other nodes by the network node.

In an advantageous embodiment of the invention, the step of automatically obtaining a certificate of another node comprises at least the steps of

initiating a negotiation according to a security parameter negotiation protocol with a second network node,

sending a request for a certificate,

receiving a certificate, and

terminating said negotiation.

According to a third further aspect of the invention, the inventive idea is realized as a method in a single network node. This third further aspect of the invention provides a method in a network node for setting up secure connections between the node and other network nodes. The method according to this aspect comprises at least the steps of

importing a collection of accepted certificates from at least one other node,

setting up of at least one secure connection to a destination node whose certificate was imported as a part of said collection, and automatically accepting the authenticity of said destination node.

According to a fourth further aspect of the invention, the inventive idea is realized as a system. This system is illustrated in FIG. 3. This fourth further aspect of the invention provides a system in a network node for setting up secure connections between network nodes. The system 200 according to this aspect comprises at least

means 202 for placing a collection of accepted certificates comprising at least one accepted certificate available for other nodes,

means 204 for importing a collection of accepted certificates from another node,

means 206 for setting up of at least one secure connection to a destination node, and

means 208 for automatically accepting the authenticity of a destination node, if the certificate of said destination node was previously imported by said means for importing.

In an advantageous embodiment of the invention, these means are implemented as computer program code executed by the network node.

According to a fifth further aspect of the invention, the inventive idea is realized as a computer program product. This fifth further aspect of the invention provides a computer program product for setting up secure connections between network nodes. The computer program product according to this aspect comprises at least

computer program code means for placing a collection of accepted certificates comprising at least one accepted certificate available for other nodes,

computer program code means for importing a collection of accepted certificates from another node,

computer program code means for setting up of at least one secure connection to a destination node, and

computer program code means for automatically accepting the authenticity of a destination node, if the certificate of said destination node was previously imported by said means for importing.

According to a further advantageous embodiment of the invention, the computer program product comprises at least

computer program code means for obtaining a certificate of a remote node,

computer program code means for displaying at least an identification string of said certificate to the user of the computer program product,

computer program code means for receiving an indication of acceptance or rejection of trust regarding said certificate from said user, and

computer program code means for storing at least an indication of the acceptance and said certificate in the case of receiving an indication of acceptance.

According to a further advantageous embodiment of said fifth further aspect of the invention, the computer program product further comprises firewall functionality.

According to a further advantageous embodiment of said fifth further aspect of the invention, the computer program product is an IPSec client program.

The computer program product can be implemented in many different ways. For example, the computer program product can be implemented as an application program executed in a computer device or as an application program stored on a computer readable media such as a hard disk, a CD-ROM, an electronic memory module, or on on other media. The computer program product can also be implemented as a subroutine library for inclusion in other programs.

According to a sixth further aspect of the invention, the inventive idea is realized as a computer in a network having network nodes. The computer according to this aspect comprises at least

computer program code means for placing a collection of accepted certificates comprising at least one accepted certificate available for other nodes.

computer program code means for importing a collection of accepted certificates from another node,

computer program code means for setting up of at least one secure connection to a destination node, and

computer program code means for automatically accepting the authenticity of a destination node, if the certificate of said destination node was previously imported by said means for importing.

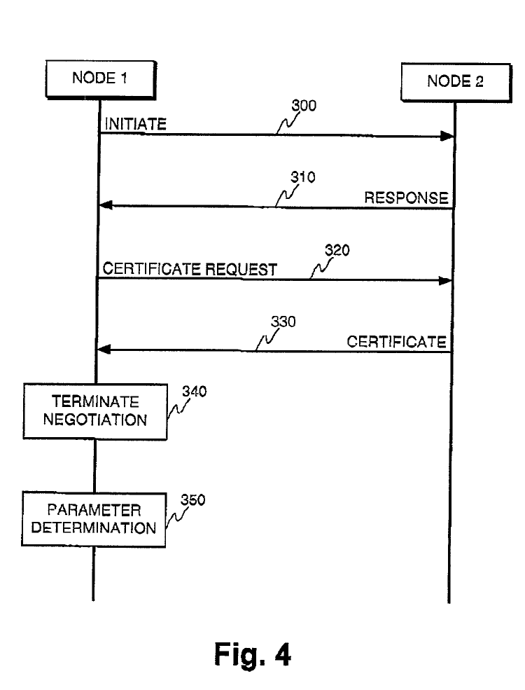

A method according to a further advantageous embodiment of the invention is illustrated in FIG. 4. This method describes in more detail how a certificate can be obtained from the other party. The figure illustrates messaging between a first node NODE 1 and a second node NODE 2.

In step 300, the first node initiates a negotiation according to a security parameter negotiation protocol with the second network node by sending an initiation message. The second node responds in step 310. Thereafter, the first node sends 320 a certificate request, to which the second network node replies by sending 330 its certificate to the first node. After receiving the certificate, the first node terminates 340 the negotiation. Thereafter, the first node terminates 350 the connection. Depending on the particular negotiation protocol, the termination step may include active messaging by issuing a connection reset message, or simply not sending any further messages.

FIG. 4 illustrates an example of a protocol. In the IKE protocol (see section 5.1 in [IKE]), messages 300 and 310 correspond to first and second messages in main mode, while messages 320 and 330 correspond to fifth and sixth messages in main mode.

In a further advantageous embodiment of the invention, the partial negotiation is used for determining a connection parameter value based at least in part on information received during said negotiation. This connection parameter value can then be used in later connection negotiations with the same remote party. Advantageously, the connection parameter value can be determined based at least in part on information in the received certificate. The connection parameter value can also be determined based at least in part on manufacturer identification information such as a vendor ID field value received from the other node.

In a further advantageous embodiment of the invention, the partial negotiation is used for determining if a packet has been modified during transit from said second node, and determining a parameter value based on the result of said determining if a packet has been modified.

### FURTHER CONSIDERATIONS

The invention has been described using some particular advantageous embodiments as examples. However, various implementations of the invention are not limited to the described examples, and the invention can be realized in many different ways within the scope of the attached patent claims. For example, in addition to IPv4 networks, the invention can be used in IPv6 networks as well.

Although this specification discusses the use of the IKE protocol as the protocol used for negotiating connection parameters, the invention is not limited to using IKE protocol. At the time of writing of this patent application, successors to the IKE protocol are under discussion at the Internet Engineering Task Force. Some currently debated proposals are known as IKEv2, SIGMA, and JFK. The UMTS cellular telecommunication networks use a negotiation protocol known as AKA. Any of these protocols could be used as the negotiation protocol in different embodiments of the invention as well as the future protocol resulting from the current protocol debate at the IETF.

### REFERENCES

The following documents are all incorporated herein by reference:

[DHCP] draft-ietf-ipsec-dhcp-13.txt, “DHCPv4 Configuration of IPsec Tunnel Mode”, B. Patel, B. Aboba, S. Kelly, V. Gupta, available at the time of writing of this patent application at http://www.ietf.org/internet-drafts/draft-ietf-ipsec-dhcp-13.txt.

[IKE] RFC 2409, “The Internet Key Exchange (IKE)”, D. Harkins, D. Carrel, November 1998.

[IP] RFC 791, “Internet Protocol”, J. Postel, September 1981.

[IPSEC] RFC 2401, “Security Architecture for the Internet Protocol”, S. Kent, R. Atkinson, November 1998.

[ISAKMP] RFC 2408, “Internet Security Association and Key Management Protocol (ISAKMP)”, D. Maughan, M. Schertler, M. Schneider, J. Turner, November 1998.

[NAT] Internet drafts draft-ietf-ipsec-nat-t-ike-01.txt, draft-ietf-ipsec-udp-encaps-justification-00.txt. and draft-ietf-ipsec-udp-encaps-01.txt, available at the time of writing of this patent application from http://www.ietf.org/internet-drafts/.

[TCP] RFC 793. “Transmission Control Protocol”, J. Postel, September 1981.

1. A method for providing authentication for setting up secure connections between a plurality of network nodes comprising at least the steps of
placing a collection of accepted certificates comprising at least one accepted certificate available for other nodes by said first node,
importing said collection by at least one other node than said first node,
setting up of at least one secure connection by at least one of said at least one other node to a destination node whose certificate was imported as a part of said collection, and automatically accepting the authenticity of said destination node.

2. A method according to claim 1 further comprising at least the steps of
automatically obtaining a certificate of a second node by a first node,
displaying at least an identification string of said certificate to the user of said first node,
receiving an indication of acceptance or rejection of trust regarding said certificate from said user, and in the case of receiving an indication of acceptance, storing at least an indication of the acceptance and said certificate, and
setting up a secure connection from said first node to said second node.

3. A method according to claim 1 further comprising at least the step of digitally signing said collection by said first node.

4. A method according to claim 1 further comprising at least the steps of encryption of said collection by said first node.

5. A method according to claim 1 further comprising at least the step of saving certificate use policy information in said collection by said first node.

6. A method according to claim 1 further comprising at least the step of digitally signing each certificate in said collection by said first node.

7. A method in a network node for setting up secure connections between the node and other network nodes comprising at least the steps of
automatically obtaining a certificate of a second node by the network node,
displaying at least an identification string of said certificate to the user of the network node,
receiving an indication of acceptance or rejection of trust regarding said certificate from said user, and in the case of receiving an indication of acceptance, storing at least an indication of the acceptance and said certificate,
setting up a secure connection from the network node to said second node, and
placing a collection of accepted certificates comprising at least one accepted certificate available for other nodes by the network node.

8. A method in a network node for setting up secure connections between the node and other network nodes comprising at least the steps of
importing a collection of accepted certificates from at least one other node,
setting up of at least one secure connection to a destination node whose certificate was imported as a part of said collection, and automatically accepting the authenticity of said destination node.

9. A system in a network node for setting up secure connections between network nodes comprising at least
means for placing a collection of accepted certificates comprising at least one accepted certificate available for other nodes,
means for importing a collection of accepted certificates from another node,
means for setting up of at least one secure connection to a destination node, and
means for automatically accepting the authenticity of a destination node, if the certificate of said destination node was previously imported by said means for importing.

10. A computer program product for setting up secure connections between network nodes comprising at least
computer program code means for placing a collection or accepted certificates comprising at least one accepted certificate available for other nodes,
computer program code means for importing a collection of accepted certificates from another node,
computer program code means for setting up of at least one secure connection to a destination node, and
computer program code means for automatically accepting the authenticity of a destination node, if the certificate of said destination node was previously imported by said means for importing.

11. A computer program product according to claim 10 further comprising firewall functionality.

12. A computer program product according to claim 10 wherein the computer program product is an IPSec client program.

13. A computer program product according to claim 10, further comprising
computer program code means for obtaining a certificate of a remote node,
computer program code means for displaying at least an identification string of said certificate to the user of the computer program product,
computer program code means for receiving an indication of acceptance or rejection of trust regarding said certificate from said user, and
computer program code means for storing at least an indication of the acceptance and said certificate in the case of receiving an indication of acceptance.

14. A computer in a network having network nodes comprising at least
computer program code means for placing a collection of accepted certificates comprising at least one accepted certificate available for other nodes,
computer program code means for importing a collection of accepted certificates from another node,
computer program code means for setting up of at least one secure connection to a destination node, and
computer program code means for automatically accepting the authenticity of a destination node, if the certificate of said destination node was previously imported by said means for importing.

15. A method for automatic configuration of a network node, wherein the method comprises at least the steps of
initiating a negotiation according to a security parameter negotiation protocol with a second network node,
sending a request for a certificate,
receiving a certificate,
terminating said negotiation, and
determining a connection parameter value based at least in part on information received during said negotiation.

16. A method according to claim 15 further comprising the step of determining a parameter value based at least in part on information in said received certificate.

17. A method according to claim 15 further comprising the step of determining a parameter value based at least in part on manufacturer identification information received from said second network node.

18. A method according to claim 15 further comprising the steps of
determining if a packet has been modified during transit from said second node, and
determining a parameter value based on the result of said determining if a packet has been modified.

19. A method according to claim 15 wherein said protocol is the IKE protocol.
